(19) United States
(12) Patent Application Publication
(10) Pub. No.: US 2019/0156591 A1
(43) Pub. Date: May 23, 2019

(54) DYNAMIC TELEMATICS VEHICLE ISSUE RESOLUTION USING A CONNECTED DEVICE

(71) Applicant: GENERAL MOTORS LLC, Detroit, MI (US)

(72) Inventors: Jared D Scheuerlein, Utica, MI (US); Esteban Camacho, Belleville, MI (US); Ryan Olejniczak, Clinton Township, MI (US)

(21) Appl. No.: 15/817,358

(22) Filed: Nov. 20, 2017

(51) Int. Cl. G07C 5/00; G07C 5/08

(52) U.S. Cl. CPC G07C 5/008; G07C 5/0841; G07C 5/0808

(57) ABSTRACT

A method for dynamic telematics vehicle issue resolution using a connected device includes opening an end user program downloaded to a customer connected device, and sending a selected vehicle issue to resolve to a remote vehicle issue resolution center from the customer connected device through the end user program. An instruction to perform at least one remedial action related to resolving the selected vehicle issue is returned to the customer connected device and, after receiving a verification that the at least one remedial action has been performed, at least one issue resolution action undertaken at the remote vehicle resolution center to resolve the vehicle issue.

### TECHNICAL FIELD

The present invention relates to systems and methods for resolving vehicle issues using dynamic telematics and, more particularly, to systems and methods of dynamic telematics vehicle issue resolution using customer connected devices such as smartphones and computers, merely as examples.

### BACKGROUND

Many original equipment manufacturers (OEMs) have equipped vehicles with systems that can be accessed and/or controlled remotely via a mobile device such as a smartphone or computer. For example, some vehicles now come equipped with systems that respond to user commands transmitted from a mobile device by way of an application supported on the mobile device. Vehicle users now may access and command an increasing number of vehicle systems. Merely by way of example, users may access vehicle information such as tire pressure, fuel level, oil level, recent fuel economy via these applications. Additionally, users now may send a variety of vehicle commands by way of these applications, such as unlocking/locking the vehicle, remotely starting the engine, or activating a horn or alarm of the vehicle.

The increasing number of available vehicle commands has led to increased demands placed upon communication systems employed by the vehicle and/or manufacturer for sending and receiving vehicle commands. The intensity of activity the communication systems must support may also widely vary. Merely as one example, a large number of vehicle users today subscribe to customer services/technical support systems via their mobile devices. Caller activity on such systems may increase on certain days of the week and/or at certain times of day, for example at the end of the business day during the work week when a relatively large number of users noticing vehicle issues as they prepare to leave their office. A variety of other factors impacts system activity, creating a wide swing in system demand. This large variance in activity forces compromises in communication system facility design, as maximizing capability to meet peak demand results in cost inefficiencies during non-peak demand conditions. While rule-based systems may improve efficiency, e.g., by increasing capacity at certain times of day/week, the wide variety of factors, e.g., customer supports calls, impacting system activity intensity still causes system inefficiencies.

Accordingly, there is a need for an improved dynamic telematics customer issue resolution system and method for vehicles that addresses the above shortcomings.

### SUMMARY

An exemplary method of dynamic telematics vehicle issue resolution using a customer connected device includes opening an end user program downloaded to a customer connected device. Another aspect of the exemplary embodiment includes sending a selected vehicle issue to resolve to a remote vehicle issue resolution center from the customer connected device through the end user program. And still another aspect includes returning an instruction to perform at least one remedial action related to resolving the selected vehicle issue to the customer connected device. And another aspect includes performing at least one issue resolution action at the remote vehicle issue resolution center in response to receiving a verification that the at least one remedial action has been performed.

A further aspect of the exemplary embodiment includes checking at least one customer account parameter associated with a customer account. Yet a further aspect wherein checking at least one customer account parameter further includes verifying account status. And another aspect wherein checking at least one customer account parameter further includes confirming vehicle telematics address is valid. Still another aspect wherein checking at least one customer account parameter further includes reviewing vehicle issue resolution history.

Another aspect in accordance with the exemplary embodiment includes sending a status report back to the end user program on the customer connected device relative to the selected vehicle issue. Still another aspect wherein sending a status report further includes reporting that the at least one resolution action failed and to call customer service. And still another aspect wherein sending a status report further comprises sending a report that the at least one resolution action succeeded but other vehicle issues exist that need resolving.

Yet another aspect of the exemplary embodiment includes opening a predefined vehicle issue resolution tab provided in the end user program for selecting the vehicle issue to resolve. Still yet another aspect wherein opening a predefined vehicle issue resolution tab provided in the end user program downloaded to the customer connected device further includes downloading the end user program to a smartphone. And one other aspect wherein opening a predefined vehicle issue resolution tab provided in an end user program downloaded to the customer connected device further comprises downloading the end user program to a computer.

Further features, aspects and advantages of the present invention will become apparent by reference to the following description and appended drawings wherein like reference numbers refer to the same component, element or feature.

### BRIEF DESCRIPTION OF THE DRAWINGS

One or more exemplary embodiments will hereinafter be described in conjunction with the appended drawings, wherein like designations denote like elements, and wherein:

FIG. 1 is a block diagram depicting an embodiment of a communications system that is capable of utilizing the exemplary method(s) disclosed herein; and

FIG. 2 is a process flow diagram of an exemplary method of dynamic telematics vehicle issue resolution using a customer connected device in accordance with aspects of an exemplary embodiment.

### DETAILED DESCRIPTION OF THE ILLUSTRATED EMBODIMENT(S)

Exemplary illustrations are described herein of a vehicle and associated methods of providing dynamic telematics vehicle issue resolution using a customer connected device.

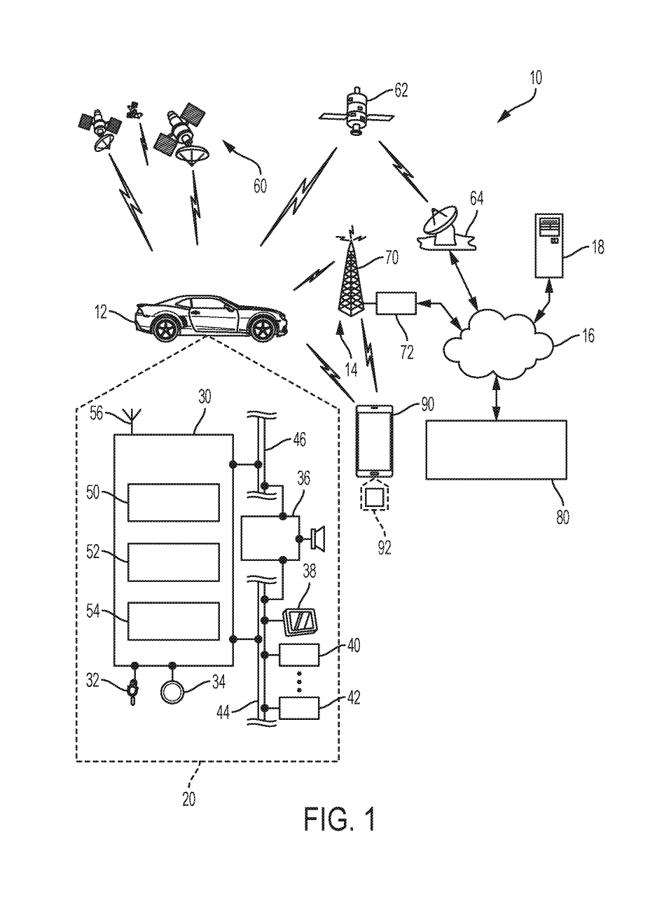

With reference to FIG. 1, there is shown an operating environment that comprises a mobile vehicle communications system 10 and that can be used to implement the methods disclosed herein. Communications system 10 generally includes a vehicle 12, one or more wireless carrier systems 14, a land communications network 16, a database 18, a remote vehicle issue resolution center 80, and a customer connected device 90. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed methods as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 20 are shown generally in FIG. 1 and include a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with the remote vehicle issue resolution center 80, other telematics-enabled vehicles (not shown), or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the remote vehicle issue resolution center 80) and data communication (e.g., to provide GPS location data or vehicle diagnostic data to the remote vehicle issue resolution center 80), the system can utilize a single call over a voice channel and switch as needed between voice and data transmission over the voice channel, and this can be done using techniques known to those skilled in the art.

According to one embodiment, telematics unit 30 utilizes cellular communication according to GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™, Wi-Fi direct, Bluetooth, or near field communication (NFC). When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; call center customer service or technical support services; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to the remote vehicle issue resolution center 80 or other remote computer system, such as database 18, for other purposes, such as confirming that the vehicle telematics transceiver address is valid. Also, new or updated map data can be downloaded to the GPS module 40 from the remote vehicle issue resolution center 80 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 20 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the remote vehicle issue resolution center 80. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to the remote vehicle issue resolution center 80. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, remote facility 80 need not be connected via land network 16, but could include wireless telephony equipment so that it can communicate directly with a wireless network, such as wireless carrier system 14.

Database 18 can be one of a number of databases accessible via a private or public network such as the Internet. Each such database 18 can be used for one or more purposes, such as a web server accessible by the vehicle via telematics unit 30 and wireless carrier 14. Other such accessible databases 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or remote vehicle issue resolution center 80, or both. A database 18 can also be used for providing Internet connectivity such as DNS services or as a network address server that uses DHCP or other suitable protocol to assign an IP address to the vehicle 12.

Remote vehicle issue resolution center 80 is designed to provide the vehicle electronics 20 with a number of different system back-end functions. The remote vehicle issue resolution center 80 may include one or more switches, servers, databases, live advisors, as well as an automated voice response system (VRS), all of which are known in the art. Remote vehicle issue resolution center 80 may include any or all of these various components and, preferably, each of the various components are coupled to one another via a wired or wireless local area network. Remote vehicle issue resolution center 80 may receive and transmit data via a modem connected to land network 16. A database 18 at the remote vehicle issue resolution center 80 can store account information such as subscriber authentication information, vehicle identifiers, profile records, behavioral patterns, and other pertinent subscriber information. Data transmissions may also be conducted by wireless systems, such as 882.11x, GPRS, and the like. Although the illustrated embodiment has been described as it would be used in conjunction with a manned remote vehicle issue resolution center 80 using a live advisor, it will be appreciated that the remote vehicle issue resolution center can instead utilize a VRS as an automated advisor or, a combination of the VRS and the live advisor can be used.

Customer connected device 90 is a non-vehicle device, meaning that it is not a part of vehicle 12 or vehicle electronics 20. The customer connected device includes: hardware, software, and/or firmware enabling cellular telecommunications and/or short range wireless communication (SRWC), as well as other wireless device functions and applications. The hardware of customer connected device 90 comprises a processor and memory for storing the software, firmware, etc. This memory may include volatile RAM or other temporary powered memory, as well as a non-transitory computer readable medium that stores some or all of the software needed to carry out the various external device functions discussed herein. The customer connected device processor and software stored in the memory enable various software applications, which may be preinstalled or installed by the user (or manufacturer) (e.g., having a software end user program/application or graphical user interface (GUI)). This may include an end user program 92 that can allow a vehicle user to communicate with vehicle 12 and/or to control various aspects or functions of the vehicle—e.g., among other things, allowing the user to remotely lock/unlock vehicle doors, turn the vehicle ignition on or off, check the vehicle tire pressures, fuel level, oil life, etc. The end user program 92 may also be used to enable the user of customer connected device 90 to view information pertaining to the vehicle (e.g., the current location of the vehicle, whether the vehicle is locked or unlocked) and/or pertaining to an account associated with the user or vehicle. Wireless device 90 is shown as a smartphone having cellular telephone capabilities. In other embodiments, device 90 may be a tablet, laptop computer, or any other suitable device. In addition, end user program 92 may also allow the user to connect with the remote vehicle issue resolution center 80 or call center advisors at any time.

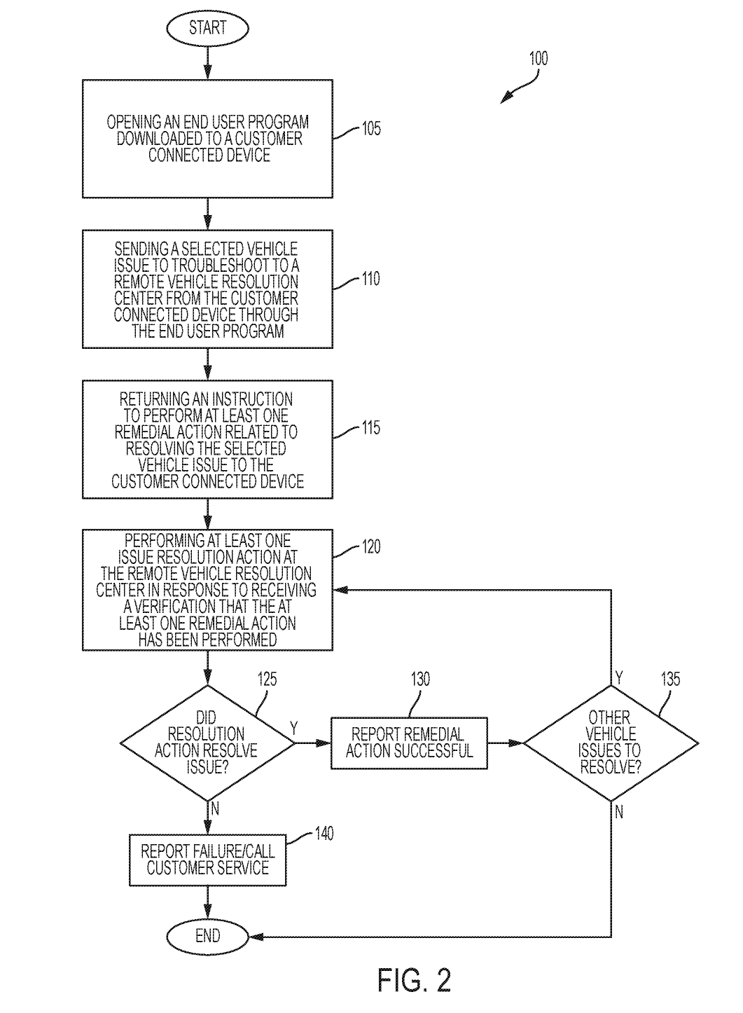

Turning now to FIG. 2, a process flow diagram of an exemplary method of dynamic telematics vehicle issue resolution using a customer connected device is shown. Process 100 begins at block 105, with a user may logging in and opening an end user program downloaded to a customer connected device. For example, a user may access vehicle issue resolution application 92, which is supported by the customer connected device 90. The login may require the user to enter credentials such as a user identification and/or password to gain access to the end user program 92. In other examples, biometric information, e.g., a fingerprint, may be required to access the mobile device 90 which in turn unlocks access to the end user program 92. The user may send vehicle action requests and receive communications from the vehicle 12 and/or remote vehicle issue resolution center 80 by way of the end user program 92 via a predefined vehicle issue resolution tab (not shown) provided in an end user program 92. It is appreciated that the end user program 92 may be downloaded the customer connected device, i.e., smartphone, computer, etc., by accessing it through the internet or the device's application store. While a single customer connected device 90 is illustrated in FIG. 1 that is associated with vehicle 12, an additional vehicle(s) (not shown) and associated customer connected devices 90 may be provided. For example, as will be described further below, in some exemplary illustrations a large number of customer connected devices 90 may be in communication with respective vehicles, and the remote vehicle issue resolution center 80 may facilitate such communication. Process 100 then proceeds to block 105.

At block 105, the process continues with sending a selected vehicle issue to resolve to the remote vehicle issue resolution center or central office from the customer connected device through the end user program. Merely as examples, a user may send a request via the customer connected device 90 to initiate a air bag system check of the vehicle 12, or HVAC system check of the vehicle 12. The remote vehicle issue resolution center 80 may facilitate the vehicle action request, e.g., by receiving the request from the customer connected device 90, performing at least one issue resolution action at the remote vehicle issue resolution center 80, and/or reporting a status of the vehicle 12 with respect to the request back to customer connected device without any human intervention at the remote vehicle issue resolution center 80.

Before beginning to resolve the requested vehicle issue, the remote vehicle issue resolution center may proceed with checking at least one customer account parameter associated with a customer's account. For example, the process may include verifying account status, vehicle telematics transceiver address is valid so connection with the remote vehicle issue resolution center can provide assistance, and/or reviewing vehicle issue resolution history to assess whether the current request for resolution assistance has been previously requested.

Proceeding to block 115, the process may continue with returning an instruction to perform at least one remedial action related to resolving the selected vehicle issue to the customer connected device 90. For example, an instruction asking the driver to turn off the vehicle ignition for a period and then restarting the engine may be sent to the customer connected device before the remote vehicle issue resolution center 80 can continue resolving an issue.

Proceeding to block 120, the process continues with performing at least one issue resolution action at the remote vehicle issue resolution center in response to receiving a verification that the at least one remedial action has been performed by the user. For example, the remote vehicle issue resolution system center 80 may perform a diagnostic test on the air bag system to check for issues that can be resolved over the air (OTA) as opposed to requiring shop service.

Next, at block 125, process 100 may continue with determining the outcome of performing the at least one resolution action at the remote vehicle issue center 80. If the resolution action taken at the remote vehicle issue center 80 is determined to have resolved the vehicle issue then, at block 130, the process continues with sending a report to the user that the at least one resolution action succeeded but other vehicle issues exist that need resolving that can also be resolved. At block 135, if the user decides to have the other existing issues resolved then a request is sent to proceed. As such, the process returns to block 120 to continue. If the resolution action taken at the remote vehicle issue center 80 is determined to have not resolved the vehicle issue then, at block 140, the process continues with reporting that the at least one resolution action failed and to call customer service call center for further assistance or that the vehicle should be taken in for service.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method for dynamic telematics vehicle issue resolution using a connected device comprising:
opening an end user program downloaded to a customer connected device;
sending a selected vehicle issue to resolve to a remote vehicle issue resolution center from the customer connected device through the end user program;
returning an instruction to perform at least one remedial action related to resolving the selected vehicle issue to the customer connected device; and
performing at least one issue resolution action at the remote vehicle issue resolution center in response to receiving a verification that the at least one remedial action has been performed.

2. The method of claim 1 further comprising checking at least one customer account parameter associated with a customer account.

3. The method of claim 2 wherein checking at least one customer account parameter further comprises verifying account status.

4. The method of claim 2 wherein checking at least one customer account parameter further comprises confirming vehicle telematics transceiver address is valid.

5. The method of claim 2 wherein checking at least one customer account parameter further comprises reviewing vehicle issue resolution history.

6. The method of claim 1 further comprising sending a status report back to the end user program on the customer connected device relative to the selected vehicle issue.

7. The method of claim 6 wherein sending a status report further comprises reporting that the at least one resolution action failed and to call customer service.

8. The method of claim 6 wherein sending a status report further comprises sending a report that the at least one resolution action succeeded but other vehicle issues exist that need resolving.

9. The method of claim 1 further comprising opening a predefined vehicle issue resolution tab provided in the end user program for selecting the vehicle issue to resolve.

10. The method of claim 1 wherein opening a predefined vehicle issue resolution tab provided in the end user program downloaded to the customer connected device further comprises downloading the end user program to a smartphone.

11. The method of claim 1 wherein opening a predefined vehicle issue resolution tab provided in an end user program downloaded to the customer connected device further comprises downloading the end user program to a computer.

12. A method for dynamic telematics vehicle issue resolution using a connected device comprising:
opening an end user program downloaded to a customer connected device;
sending a selected vehicle issue to resolve to a remote vehicle issue resolution center from the customer connected device through the end user program;
checking at least one customer account parameter associated with a customer account;
returning an instruction to perform at least one remedial action related to resolving the selected vehicle issue to the customer connected device; and
performing at least one issue resolution action at the remote vehicle issue resolution center in response to receiving a verification that the at least one remedial action has been performed.

13. The method of claim 12 wherein checking at least one customer account parameter further comprises verifying account status.

14. The method of claim 12 wherein checking at least one customer account parameter further comprises confirming vehicle telematics transceiver address is valid.

15. The method of claim 2 wherein checking at least one customer account parameter further comprises reviewing vehicle issue resolution history.

16. The method of claim 12 further comprising sending a status report back to the end user program on the customer connected device relative to the selected vehicle issue.

17. The method of claim 16 wherein sending a status report further comprises reporting that the at least one resolution action failed and to call customer service.

18. The method of claim 16 wherein sending a status report further comprises sending a report that the at least one resolution action succeeded but other vehicle issues exist that need resolving.

19. The method of claim 12 further comprising opening a predefined vehicle issue resolution tab provided in the end user program for selecting the vehicle issue to resolve.

20. The method of claim 12 wherein opening a predefined vehicle issue resolution tab provided in the end user program downloaded to the customer connected device further comprises downloading the end user program to a smartphone.
